(19) United States
(12) Patent Application Publication
(10) Pub. No.: US 2013/0311718 A1
(43) Pub. Date: Nov. 21, 2013

(54) SYSTEM AND METHOD OF MAKING GOLDEN MASTER

(71) Applicants: Hong Fu Jin Precision Industry (ShenZhen) Co., Ltd., (US); HON HAI PRECISION INDUSTRY CO., LTD., New Taipei (TW)

(72) Inventors: GANG LIU, Shenzhen (CN); HAI-HUI WU, Shenzhen (CN); GEN-SHENG LI, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/804,117

(22) Filed: Mar. 14, 2013

(30) Foreign Application Priority Data
May 15, 2012 (CN) 201210149659.4

(51) Int. Cl. G06F 3/06

(52) U.S. Cl. CPC G06F 3/0674
USPC 711/112

(57) ABSTRACT

A system and method of making golden master is disclosed. A user image is burned to a hard disk drive. The user image includes a first user partition and a second user partition. A first user partition record pointing to the first user partition and a second user partition record pointing to the second user partition are stored in the disk partition table (DPT) of the hard disk drive. A DPT clearing module removes the first and second user partition records from the DPT. A diagnostic partition is established between the starting sector address and the ending sector address of the first user partition in the hard disk drive. A diagnostic partition record pointing to the diagnostic partition is written into the DPT. A partition record resuming module adds back the first user partition record into the DPT.

### REFERENCE TO RELATED APPLICATIONS

This application claims all benefits accruing under 35 U.S.C. §119 from China Patent Application No. 201210149659.4, filed on May 15, 2012 in the State Intellectual Property Office of China. The contents of the China Application are hereby incorporated by reference. In addition, subject matter relevant to this application is disclosed in: co-pending U.S. Patent Applicant entitled “SYSTEM AND METHOD OF MAKING GOLDEN MASTER,” Attorney Docket Number US44540, application Ser. No. [to be advised], filed on the same day as the present application. This application and the co-pending U.S. Patent Application are commonly owned, and the contents of the co-pending U.S. Patent Application are hereby incorporated by reference.

### BACKGROUND

1. Technical Field

The disclosure generally relates to a system and method of making golden master.

2. Description of Related Art

A golden master is a hard disk drive on which a user image stays. The user image is to be delivered to end user. Once the golden master is made, a factory can mass-produce hard disk drives that have the same data as the golden master by cloning the golden master using a hard disk copy machine or the like. The factory can then install these hard disk drives into computers. Commonly each of the computers has to pass a set of test procedures by running a diagnostic program before being shipped out. On one hand, the user image may be corrupted if the diagnostic program is stored within the golden master. On the other hand, the diagnostic program is confidential and is not to be delivered with the user image to end user.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of a computing device suitable for employing a golden master making system.

FIG. 2 is a block diagram of one embodiment of the golden master making system of FIG. 1.

FIG. 3 is a block diagram of a golden master in which a user image is written or burned.

FIG. 4 is a block diagram of a golden master in which a diagnostic partition is established.

FIG. 5 is a block diagram of a golden master in which the first user partition record is added back.

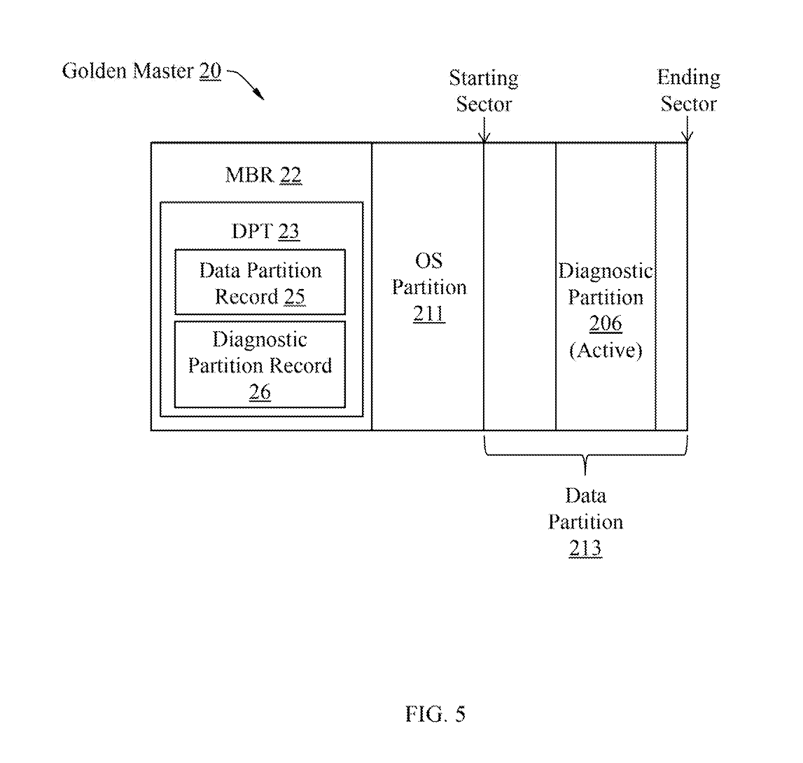

FIG. 6 is a flowchart showing one embodiment of a golden master making method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

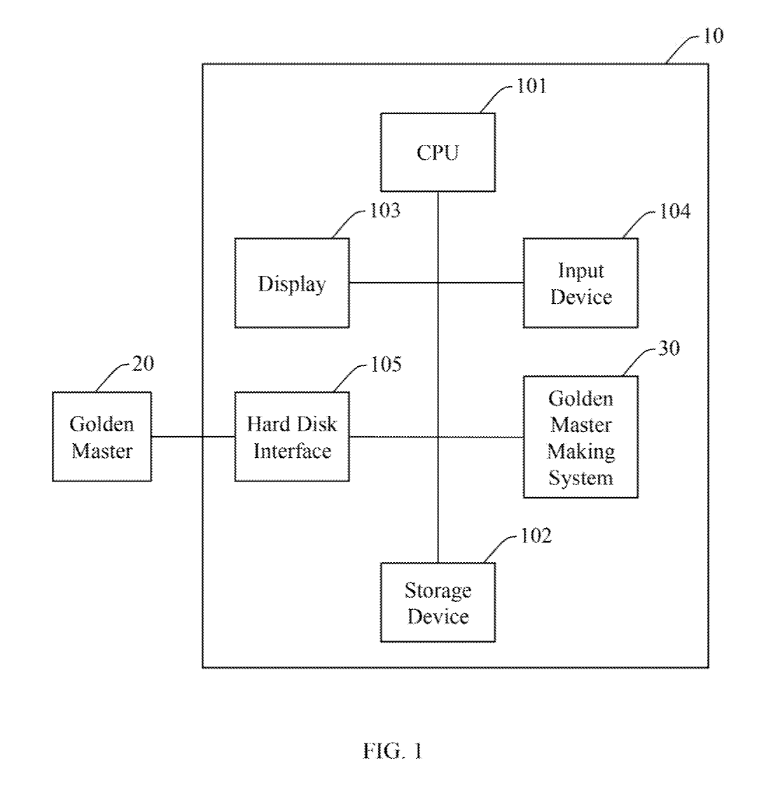

FIG. 1 shows one embodiment of a computing device 10. The computing device 10 includes a central processing unit (CPU) 101, a storage device 102, a display 103, an input device 104 and a hard disk interface 105. The computing device 10 may be a host computer, a workstation computer, a server computer, a tablet computer, a hard disk copy machine, or the like. A hard disk drive as a golden master 20 may be connected to the hard disk interface 105. A golden master making system 30 may be employed in the computing device 10 and executable by the computing device 10, and is configured for making the golden master 20.

The CPU 101 is operably coupled to the storage device 102, the display 103, the input device 104, and the hard disk interface 105. The CPU 101 may include one or more processors that provide the processing capability to execute the operating system, programs, user and application interfaces, and any other functions of the computing device 10. The CPU 101 may include one or more microprocessors and/or related chip sets. For example, the CPU 101 may include “general purpose” microprocessors, a combination of general and special purpose microprocessors, instruction set processors, graphics processors, video processors, related chips sets, and/or special purpose microprocessors. The CPU 101 also may include onboard memory for caching purposes.

Information, such as programs and/or instructions, used by the CPU 101 may be located within the storage device 102. The storage device 102 may store a variety of information and may be used for various purposes. For example, the storage device 102 may store firmware for the computing device 10 (such as a basic input/output instruction or operating system instructions), various programs, applications, or routines executed on the computing device 10, user interface functions, processor functions, and so forth. In addition, the storage device 102 may be used for buffering or caching during operation of the computing device 10.

The storage device 102 may include any suitable manufacture that includes one or more tangible, computer-readable media. For example, the storage device 102 may include a volatile memory, such as random access memory (RAM), and/or as a non-volatile memory, such as read-only memory (ROM). The components may further include other forms of computer-readable media, such as non-volatile storage, for persistent storage of data and/or instructions. The non-volatile storage may include flash memory, a hard drive, or any other optical, magnetic, and/or solid-state storage media. The non-volatile storage may be used to store firmware, data files, software, wireless connection information, and any other suitable data.

The display 103 may provide a visual output interface between the computing device 10 and a user. The visual output may include text, graphics, video, and any combination thereof. The display 103 may use LCD (liquid crystal display) technology, or LPD (light emitting polymer display) technology, although other display technologies may be used in other embodiments. In some embodiments, the display 103 may be a touch-sensitive display which also accepts input from the user based on haptic and/or tactile contact through a touch-sensitive surface.

The input device 104 may provide an input interface between the computing device 10 and a user. The input device 104 may be a keyboard, a mouse or a touch pad, for the input of information.

The hard disk interface 105 may provide connectivity channels for reading/writing data from/to the golden master 20. The hard disk interface 105 may represent, for example, a serial advanced technology attachment (SATA) controller or a small computer system interface (SCSI).

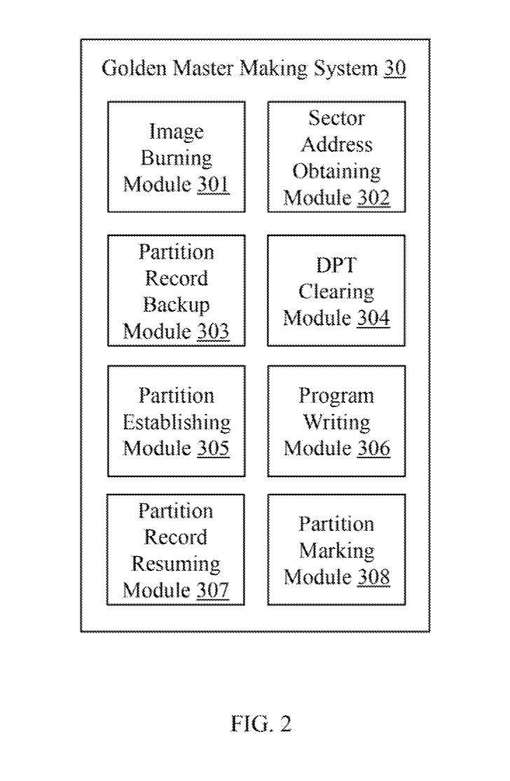

FIG. 2 shows a functional block diagram of one embodiment of the golden master making system 30. The golden master making system 30 includes an image burning module 301, a sector address obtaining module 302, a partition record backup module 303, a disk partition table (DPT) clearing module 304, a partition establishing module 305, a program writing module 306, a partition record resuming module 307, and a partition marking module 308.

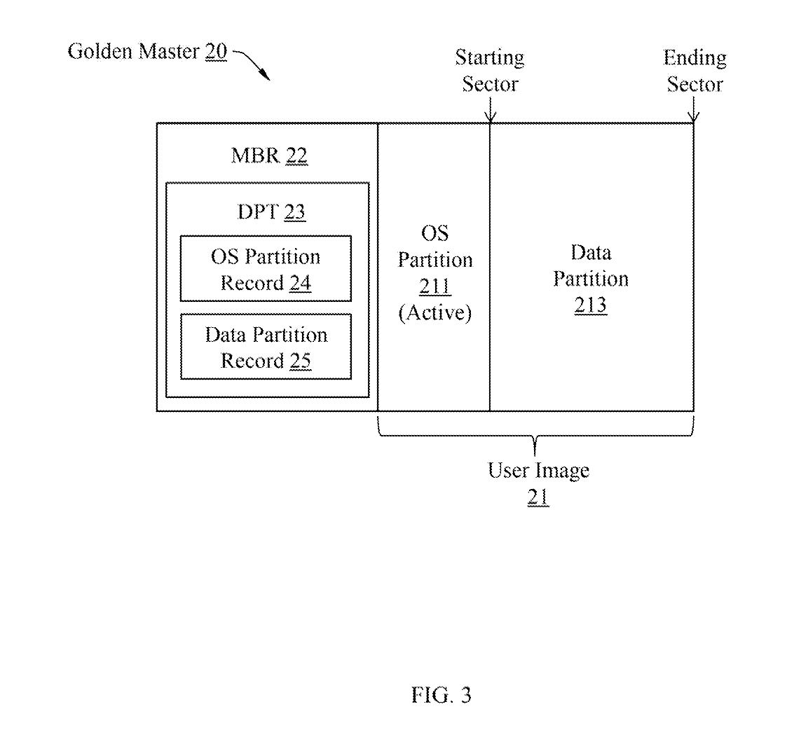

The image burning module 301 may write or burn a user image 21 to the golden master 20. Referring to FIG. 3, the user image 21 includes two user partitions which are an operating system (OS) partition 211, and a data partition 213. The golden master 20 further includes a main boot record (MBR) 22. The MBR 22 includes a DPT 23 which stores an OS partition record 24 pointing to the OS partition 211 and a data partition record 25 pointing to the data partition 213. The data partition record 25 records a starting sector address and a partition size of the data partition 213. As shown in FIG. 3, the OS partition 211 is marked as active so that a computer which is equipped with a hard disk drive cloned from the golden master 20 may be booted from the OS partition 211.

The sector address obtaining module 302 may read a starting sector address and a partition size of the data partition 213 from the data partition record 25, and calculate an ending sector address of the data partition 213 according to the starting sector address and the partition size of the data partition 213. As shown in FIG. 3, the starting sector address and the ending sector address of the data partition 213 are obtained by the sector address obtaining module 302.

The partition record backup module 303 may duplicate the OS partition record 24 and the data partition record 25. In some embodiments, the partition record backup module 303 may copy the OS partition record 24 and the data partition record 25 to a specified sector which has an identity number between 1 and 63. The sectors with identity numbers from 1 to 63 in a hard disk drive are always idle and free to use. Therefore, the duplication of the OS partition record 24 and the data partition record 25 will not damage or negatively affect the user image.

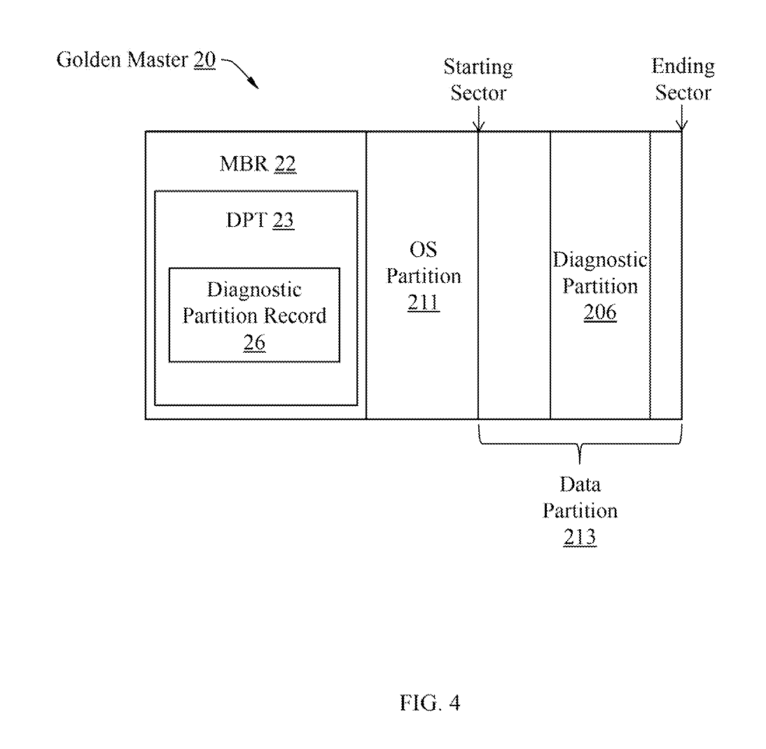

The DPT clearing module 304 may clear the DPT 23 by removing the OS partition record 24 and the data partition record 25 from the DPT 23. As shown in FIG. 4, the OS partition record 24 and the data partition record 25 have been removed from the DPT 23 and the two user partitions are all accordingly inactive.

The partition establishing module 305 may establish a diagnostic partition 206 between the starting sector address and the ending sector address of the data partition 213 in the golden master 20. As shown in FIG. 4, the partition establishing module 305 may determine a blank disk region between the starting sector address and the ending sector address of the data partition 213 in the golden master 20, and establish the diagnostic partition 206 in the blank disk region.

The partition establishing module 305 may further generate a diagnostic partition record 26 pointing to the diagnostic partition 206, and write the diagnostic partition record 26 into the DPT 23. The diagnostic partition record 26 shown in FIG. 4 has been written into the DPT 23.

The program writing module 306 may store a diagnostic program in the diagnostic partition 206 after the diagnostic partition record 26 has been written into the DPT 23. The diagnostic program may be used to launch a set of test procedures while in the factory product line.

The partition record resuming module 307 may add the data partition record 25 back into the DPT 23 after the diagnostic partition record 26 has been written into the DPT 23. Thus, the data partition record 25 and the diagnostic partition record 26 co-exist in the DPT 23. In one embodiment, the partition record resuming module 307 retrieves the data partition record 25 from the specified sector of the golden master 20 and writes the data partition record 25 into the DPT 23.

The partition marking module 308 may mark the diagnostic partition 206 as active after the diagnostic partition record 26 has been written into the DPT 23. Thus, a computer equipped with a clone of the golden master 20 may be booted from the diagnostic partition 206 and run the diagnostic program. In some embodiments, the diagnostic program may remove the diagnostic partition record 26 from the DPT 23 and add the OS partition record 24 back into the DPT 23 and mark the OS partition 211 as active after the diagnostic process is complete, so that the diagnostic program itself will not be delivered with the user image to end user.

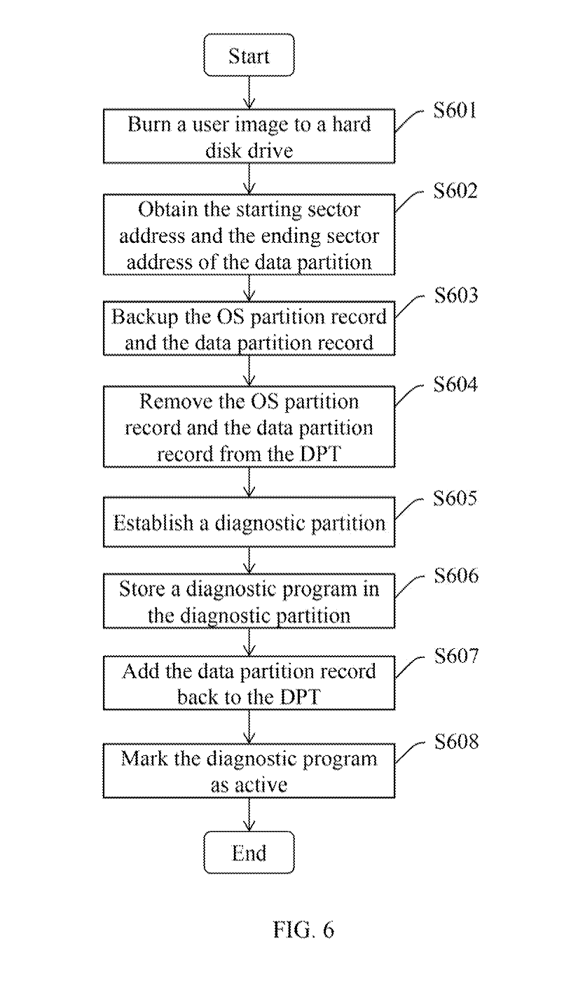

FIG. 6 is a flowchart showing one embodiment of a method of making golden master. The method comprises the following steps.

In step S601, the image burning module 301 burns a user image 21 to the golden master 20. Referring to FIG. 3, the user image 21 includes two user partitions which are an operating system (OS) partition 211 and a data partition 213. The golden master 20 further includes an MBR 22. The MBR 22 includes a DPT 23 which stores an OS partition record 24 pointing to the OS partition 211 and a data partition record 25 pointing to the data partition 213. The data partition record 25 records a starting sector address and a partition size of the data partition 213. As shown in FIG. 3, the OS partition 211 is marked as active so that a computer equipped with a hard disk drive cloned from the golden master 20 can be booted from the OS partition 211.

In step S602, the sector address obtaining module 302 obtains the starting sector address and the ending sector address of the data partition 213. As shown in FIG. 3, the starting sector address and the ending sector address of the data partition 213 are obtained by the sector address obtaining module 302.

In step S603, the partition record backup module 303 duplicates the OS partition record 24 and the data partition record 25. In some embodiments, the partition record backup module 303 copies the OS partition record 24 and the data partition record 25 to a specified sector which has an identity number between 1 and 63. Sectors with identity numbers from 1 to 63 in a hard disk drive are always idle and free to use. Therefore, the user image will not be damaged or negatively affected by the duplication of the OS partition record 24 and the data partition record 25.

In step S604, the DPT clearing module 304 clears the DPT 23 by removing the OS partition record 24 and the data partition record 25 from the DPT 23. The OS partition record 24 and the data partition record 25 in FIG. 4 have been removed from the DPT 23 and the two user partitions are all accordingly inactive.

In step S605, the partition establishing module 305 establishes a diagnostic partition 206 between the starting sector address and the ending sector address of the data partition 213 in the golden master 20. The partition establishing module 305 generates a diagnostic partition record 26 pointing to the diagnostic partition 206, and writes the diagnostic partition record 26 into the DPT 23. FIG. 4 shows the diagnostic partition record 26 having been written into the DPT 23.

In step S606, the program writing module 306 stores a diagnostic program in the diagnostic partition 206. The diagnostic program may be used to launch a set of test procedures in the factory production line.

In step S607, the partition record resuming module 307 adds the data partition record 25 back into the DPT 23. Thus, the data partition record 25 and the diagnostic partition record 26 co-exist in the DPT 23. In one embodiment, the partition record resuming module 307 retrieves the data partition record 25 from the specified sector of the golden master 20 and writes the data partition record 25 into the DPT 23.

In step S608, the partition marking module 308 marks the diagnostic partition 206 as active. Thus, when a computer contains a hard disk drive cloned from the golden master 20, the computer may be booted from the diagnostic 206 and run the diagnostic program. In some embodiments, the diagnostic program removes the diagnostic partition record 26 from the DPT 23 and add the OS partition record 24 back into the DPT 23 and marks the OS partition 211 as active after the diagnostic process is complete, so that the diagnostic program will not be delivered with the user image to end user.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A system of making golden master, the system comprising:
an image burning module configured to burn a user image to a hard disk drive, the user image comprising a first user partition and a second user partition, the hard disk drive comprising a main boot record (MBR), the MBR comprising a disk partition table (DPT), the DPT storing a first user partition record pointing to the first user partition and a second user partition record pointing to the second user partition;
a sector address obtaining module configured to obtain a starting sector address and an ending sector address of the first user partition;
a DPT clearing module configured to remove the first user partition record and the second user partition record from the DPT;
a partition establishing module configured to establish a diagnostic partition between the starting sector address and the ending sector address in the hard disk drive, to generate a diagnostic partition record pointing to the diagnostic partition and to write the diagnostic partition record into the DPT; and
a partition record resuming module configured to add the first user partition record back into the DPT after the diagnostic partition record has been written into the DPT.

2. The system of claim 1, further comprising a partition record backup module configured to duplicate the first user partition record and the second user partition record before the step of removing the first user partition record and the second user partition record from the DPT.

3. The system of claim 2, wherein the partition record backup module further configured to copy the first user partition record and the second user partition record to a specified sector which has an identity number between 1 and 63.

4. The system of claim 3, wherein the partition record resuming module further configured to retrieve the first user partition record from the specified sector and to write the first user partition record into the DPT after the diagnostic partition record has been written into the DPT.

5. The system of claim 1, wherein the sector address obtaining module further configured to read the starting sector address and a partition size of the first user partition from the first user partition record, and to calculate the ending sector address of the first user partition according to the starting sector address and the partition size of the first user partition.

6. The system of claim 1, wherein the partition establishing module is further configured to determine a blank disk region between the starting sector address and the ending sector address of the first user partition in the disk drive, and to establish the diagnostic partition in the blank disk region.

7. The system of claim 1, further comprising a program writing module configured to store a diagnostic program in the diagnostic partition after the diagnostic partition record has been written into the DPT.

8. The system of claim 1, further comprising a partition marking module configured to mark the diagnostic partition as active after the diagnostic partition record has been written into the DPT.

9. A method of making golden master, the method comprising:
burning a user image to a hard disk drive, the user image comprising a first user partition and a second user partition, the hard disk drive comprising a main boot record (MBR), the MBR comprising a disk partition table (DPT), the DPT storing a first user partition record pointing to the first user partition and a second user partition record pointing to the second user partition;
obtaining a starting sector address and an ending sector address of the first user partition;
removing the first user partition record and the second user partition from the DPT;
establishing a diagnostic partition between the starting sector address and the ending sector address in the hard disk drive;
generating a diagnostic partition record pointing to the diagnostic partition;
writing the diagnostic partition record into the DPT; and
adding the first user partition record back into the DPT.

10. The method of claim 9, further comprising:
duplicating the first user partition record and the second user partition record before the step of removing the first user partition record and the second user partition record from the DPT.

11. The method of claim 10, wherein the step of duplicating the first user partition record and the second user partition record comprises:
coping the first user partition record and the second user partition to a specified sector which has an identity number between 1 and 63.

12. The method of claim 11, wherein the step of adding the first user partition record back into the DPT comprises:
retrieving the first user partition record from the specified sector; and
writing the first user partition record into the DPT.

13. The method of claim 9, wherein the step of obtaining the starting sector address and the ending sector address of the first user partition comprises:
reading the starting sector address and a partition size of the first user partition from the first user partition record; and
calculating the ending sector address of the first user partition according to the starting sector address and the partition size of the first user partition.

14. The method of claim 9, wherein the step of establishing the diagnostic partition between the starting sector address and the ending sector address in the hard disk drive comprises:
determining a blank disk region between the starting sector address and the ending sector address of the first user partition in the disk drive; and
establishing the diagnostic partition in the blank disk region.

15. The method of claim 9, further comprising:
storing a diagnostic program in the diagnostic partition after the diagnostic partition record has been written into the DPT.

16. The method of claim 9, further comprising:
marking the diagnostic partition as active after the diagnostic partition record has been written into the DPT.
